(19) United States
(12) Patent Application Publication
(10) Pub. No.: US 2026/0216855 A1
(43) Pub. Date: Jul. 30, 2026

(54) HYDRAULIC TOOL PUMP

(71) Applicant: Milwaukee Electric Tool Corporation, Brookfield, WI (US)

(72) Inventors: Brandon D. Meister, Brookfield, WI (US); Mathew R. Rentmeester, Wauwatosa, WI (US); Adam K. Sturgeon, Brookfield, WI (US); Justin K. Martin, West Bend, WI (US)

(21) Appl. No.: 19/465,752

(22) Filed: Jan. 30, 2026

Related U.S. Application Data
(60) Provisional application No. 63/751,671, filed on Jan. 30, 2025.

(51) Int. Cl. B25F 5/00; F04B 19/04; F15B 15/18

(52) U.S. Cl. CPC B25F 5/005; F04B 19/04; F15B 15/18

(57) ABSTRACT

A pump for a hydraulic tool includes a pump body defining a piston chamber and an inlet passage and an outlet passage that are coupled to the piston chamber. A piston is movably disposed within the piston chamber. A camshaft is rotatably supported by the pump body. The camshaft includes a cam, an inner bearing made of a first material and sleeved on the cam, and an outer bearing made of a second material that is different from the first material and sleeved on the inner bearing so that the inner bearing is between the outer bearing and the cam. A biasing member is positioned between the piston and the pump body to bias the piston into contact with the outer bearing so that the piston oscillates within the piston chamber in response to rotation of the cam.

### CROSS-REFERENCE TO RELATED APPLICATIONS

This application claims priority to U.S. Provisional Patent Application No. 63/751,671, filed on January 30, 2025, which is incorporated herein by reference in its entirety.

### FIELD

The present disclosure relates generally relates to hydraulic tools. More specifically, the present disclosure relates to a pump arrangement in a hydraulic tool.

### BACKGROUND

Hydraulic tools can include a pump and piston configuration. In some cases, the pump configuration can include a check valve that creates dead space that decreases volumetric efficiency at a high pressure. In other cases, the piston configuration can contact a camshaft therefore creating friction and reducing efficiency.

### SUMMARY

According to one aspect of the present disclosure, a pump for a hydraulic tool can be provided. The pump can include a pump body defining a piston chamber and an inlet passage and an outlet passage that are coupled to the piston chamber. A piston can be movably disposed within the piston chamber. A camshaft can be rotatably supported by the pump body. The camshaft can include a cam, an inner bearing made of a first material and sleeved on the cam, and an outer bearing made of a second material that is different from the first material and sleeved on the inner bearing so that the inner bearing is between the outer bearing and the cam. A biasing member can be positioned between the piston and the pump body to bias the piston into contact with the outer bearing so that the piston oscillates within the piston chamber in response to rotation of the cam.

In some examples, a retainer can be coupled to an end of the piston that is positioned outside of the piston chamber and the biasing member can be positioned between the pump body and the retainer.

In some examples, a cartridge valve can be positioned along the inlet passage to prevent fluid flow out of the piston chamber along the inlet passage.

In some examples, the cam can be an eccentric cam that is positioned between a first journal and a second journal. The pump body can include a first journal housing to receive the first journal and a second journal housing to receive the second journal.

In some examples, a first retainer can be coupled to the cam between the first journal and the outer bearing and a second retainer can be coupled to the cam between the second journal and the outer bearing.

In some examples, the pump can further include a piston sleeve positioned in the piston chamber. The piston sleeve can slidably receive the piston.

In some examples, the pump can further include a reservoir coupled to the pump body so that the pump body is disposed within the reservoir.

In some examples, the first material can be a metallic material and the second material can be a polymeric material.

In some examples, a cartridge valve can be positioned along the outlet passage to prevent fluid flow back into the piston chamber along the outlet passage.

According to another aspect of the present disclosure, a power tool can be provided. The power tool can include a housing. A hydraulic actuator can be supported by the housing and can include a cylinder and a ram movably disposed within the cylinder. A tank can be positioned in the housing and fluidly coupled to the hydraulic actuator. A pump can be positioned in the housing. The pump can include a pump body defining a piston chamber, an inlet passage coupled between the tank and the piston chamber, and an outlet passage coupled to the piston chamber. A piston can be movably disposed within the piston chamber. A camshaft can be rotatably supported by the pump body. The camshaft can include a cam, an inner bearing made of a first material and sleeved on the cam, and an outer bearing made of a second material that is different from the first material and sleeved on the inner bearing so that the inner bearing is between the outer bearing and the cam. A biasing member can be positioned between the piston and the pump body to bias the piston into contact with the outer bearing so that the piston oscillates within the piston chamber in response to rotation of the cam. A motor can be coupled to the camshaft to rotate the camshaft.

In some examples, the pump body can include a piston chamber body positioned between a first flange and a second flange that is coupled to the cylinder of the hydraulic actuator. The tank can be coupled to the first flange and to the cylinder so that the piston chamber body is disposed within the tank.

In some examples, the cam can be positioned between a first journal and a second journal. The first flange can define a first journal housing to receive the first journal and the second flange can define a second journal housing to receive the second journal so that the cam is disposed within the tank.

In some examples, a first retainer can be coupled to the camshaft between the first journal and the outer bearing, and a second retainer can be coupled to the camshaft between the second journal and the outer bearing.

In some examples, a third retainer can be positioned between the second retainer and the second journal.

In some examples, a first cartridge valve can be positioned along the inlet passage to prevent fluid flow from the piston chamber to the tank.

In some examples, a retainer can be coupled to an end of the piston that is positioned outside the piston chamber.

In some examples, the power tool can further include a piston sleeve positioned in the piston chamber. The piston sleeve can slidably receive the piston.

In some examples, the first material can be a metallic material and the second material can be a polymeric material.

In some examples, a second cartridge valve can be positioned along the outlet passage to prevent fluid flow back into the piston chamber along the outlet passage.

According to yet another aspect of the present disclosure, a power tool system can be provided. The power tool can include a housing. A hydraulic actuator can be supported by the housing and can include a cylinder and a ram movably disposed within the cylinder. A tank can be positioned in the housing and fluidly coupled to the hydraulic actuator. A pump can be positioned in the housing. The pump can include a pump body defining a piston chamber, an inlet passage coupled between the tank and the piston chamber, and an outlet passage coupled to the piston chamber. The piston chamber can be disposed within the tank and the inlet passage and the outlet passage can include a cartridge valve. A piston can be movably disposed within the piston chamber. The piston can include a retainer coupled to an end of the piston. A camshaft can be rotatably supported by the pump body. The camshaft can include a cam, an inner bearing made of a first material and sleeved on the cam, and an outer bearing made of a second material that is different from the first material and sleeved on the inner bearing so that the inner bearing is between the outer bearing and the cam. A biasing member can be positioned between the retainer and the pump body to bias the piston into contact with the outer bearing so that the piston oscillates within the piston chamber in response to rotation of the cam. A motor can be coupled to the camshaft to rotate the camshaft. A valve assembly positioned along a pump passage between the pump and the hydraulic actuator. The valve assembly includes a dump poppet and a relief valve received within the dump poppet.

### BRIEF DESCRIPTION OF THE DRAWINGS

The novel features believed characteristic of the illustrative embodiments are set forth in the appended claims. The illustrative embodiments, however, as well as a preferred mode of use, further objectives and descriptions thereof, will best be understood by reference to the following detailed description of one or more illustrative embodiments of the present disclosure when read in conjunction with the accompanying drawings, wherein:

FIG. 1 is an axonometric view of a hydraulic tool, according to aspects of the present disclosure.

FIG. 2 is a diagrammatic view diagram of the hydraulic tool of FIG. 1.

FIG. 3 is a top view of the hydraulic tool of FIG. 1.

FIG. 4 is a cross-sectional view of the hydraulic tool of FIG. 3, taken along IV-IV.

FIG. 5 is a detail view of the hydraulic tool of FIG. 4, taken about line V-V.

FIG. 6 is a cross-sectional view of the hydraulic tool of FIG. 3, taken along VI-VI.

FIG. 7 is a detail view of a fluid flow path in the hydraulic tool of FIG. 1.

### DETAILED DESCRIPTION

Hydraulic tools can be used to perform a work function on a workpiece (e.g., a cut, a crimp, a punch). Generally, hydraulic tools can include a pump and piston configuration, where the piston is configured to extend and retract to pump fluid to generate pressure, and thus, move jaws or any other implement coupled to the piston to perform the task. For example, a motor can operate a pump to generate a pressurized flow of hydraulic fluid that is provided from a tank to a hydraulic actuator. In the present disclosure, the tank surrounds the pump. In other cases, the tank can be located separate from the pump.

A hydraulic tool can include a pump. The pump can include a pump body that defines a piston chamber and an inlet passage and an outlet passage that are coupled to the piston chamber. A piston can be movably disposed within the piston chamber. The piston chamber can be positioned between a first flange and a second flange. The first flange can define a bearing hub. The second flange can also define a bearing hub.

In some hydraulic tools, a motor is attached to a camshaft to move a piston. The camshaft converts rotational motion into linear motion of the piston to create pressure to push fluid through the system. For example, as the camshaft rotates, the piston oscillates in the piston chamber. That is, the camshaft can move the piston in a first direction (e.g., downward into the piston chamber to generate pressurized fluid) and a second direction (e.g., upward out of the piston chamber to refill the piston chamber with fluid). The pump can include a return mechanism to bias the piston so that the piston remains in contact with the camshaft. The return mechanism includes a retainer that is coupled to the piston and a spring that is compressed between a pump body and the retainer. As the camshaft rotates, the spring is compressed between the retainer and the pump body when the piston is moved in the first direction and the spring decompresses to maintain the piston in contact with the camshaft so that the piston moves in the second direction.

To improve pump efficiency, one or more sleeves can be coupled to a cam of a camshaft. The one or more sleeves can reduce friction between the piston and the camshaft and can also improve wear resistance for reduced maintenance and improved tool life. In some examples, a sleeve can be made of a polymeric material. In other examples, a sleeve can be made of a metallic material. In some cases, a set of sleeves can be used with different sleeves being made of different materials to impart different properties to the pump.

In some examples, a pump assembly can include a check valve to prevent backflow from a pump chamber to a tank or other fluid source (e.g., a flooded chamber in a piston). In some cases, a check valve can be configured as a cartridge valve, for example, a check valve (i.e., a spring biased valve), or another type of cartridge valve. In some cases, a cartridge-style valve can be beneficial as such valves can require less space and can reduce pump size or weight.

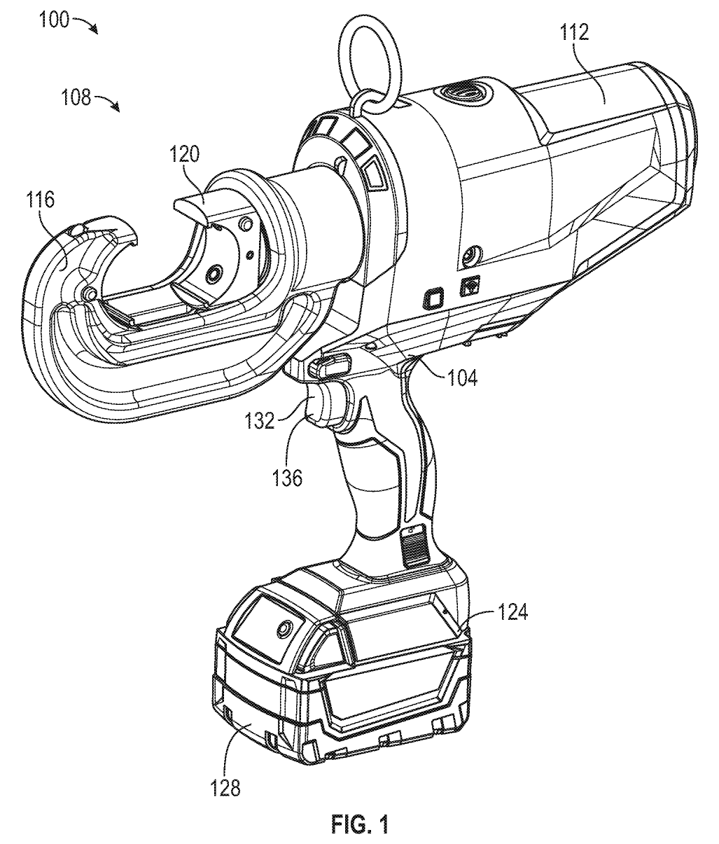

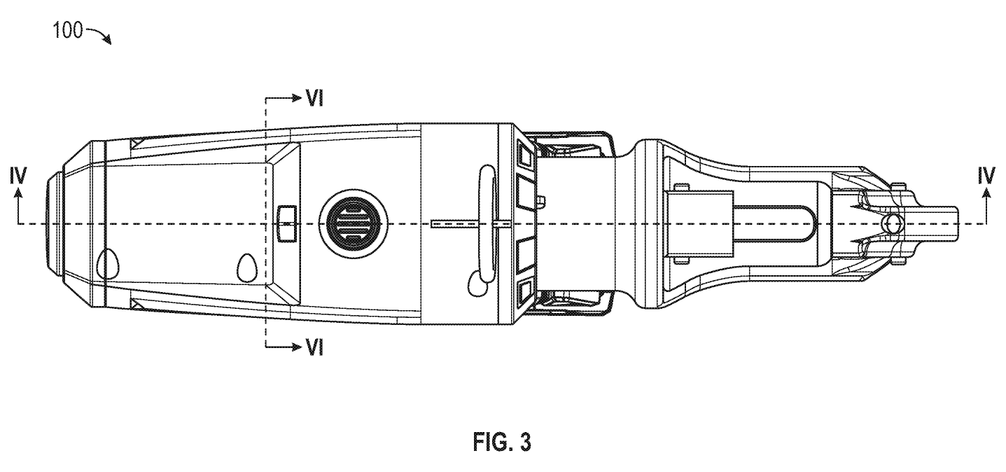

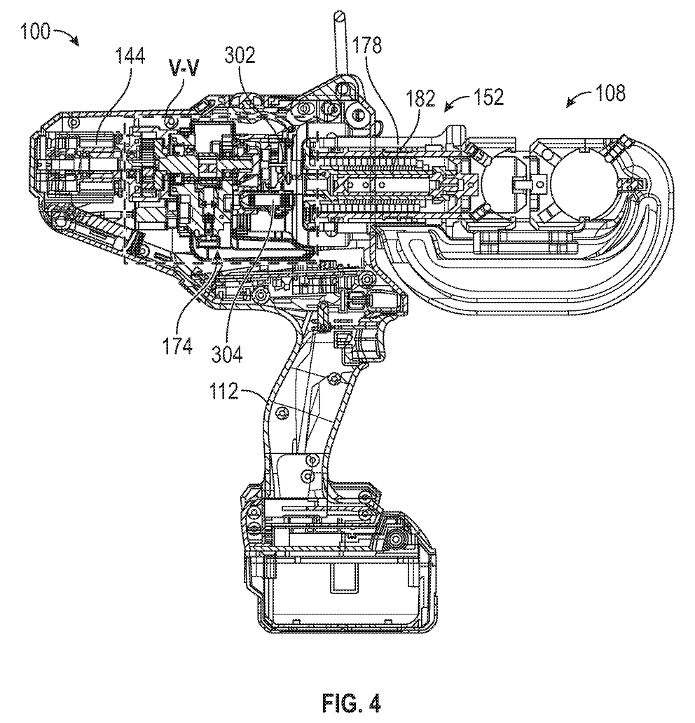

FIGS. 1-4 illustrate an example of a hydraulic tool 100, in accordance with the present disclosure. Although the example implementation described herein references a crimping tool, the features of this disclosure can be implemented in other similar tools, such as cutting tools or punching tools. In addition, any suitable size, shape or type of elements or materials could be used. The illustrated hydraulic tool 100 includes a tool body 104 (e.g., an actuator, a motor, a reservoir, electronics, etc.) and a working head 108. The tool body 104 is disposed within a housing 112 and the working head 108 is coupled to the housing 112 to perform an operation on a workpiece. The working head 108 is illustrated as a crimping head that includes jaws 116 and 120; however other types of working heads can also be used. In some examples, the hydraulic tool 100 can be battery-operated and the housing 112 can define a battery receptacle 124 that is configured to receive a battery 128. In other examples the hydraulic tool 100 can be corded.

To operate the hydraulic tool 100, a first user interface 132 that is a trigger 136 is coupled to the housing 112. The trigger 136 can be manipulated by a user to actuate the hydraulic tool 100 and perform a work operation. For example, actuating the trigger 136 can control operation of an output assembly 140 that is disposed within the housing 112. The output assembly 140 includes a motor 144, a pump 148, and a hydraulic actuator 152 that acts on the working head 108 to perform the work operation. When the trigger 136 is pressed, electrical current can flow from the battery 128 to the output assembly 140, causing the output assembly 140 to operate the working head 108 to perform the work operation. In some cases, the trigger 136 can communicate with an electronic controller 156 that controls a flow of electrical current from the battery 128 or another power source. More specifically, the electrical current can be provided to the motor 144 of the output assembly 140. The motor 144 can be coupled to the pump 148 so that rotation of the motor 144 operates the pump 148 to supply pressurized hydraulic fluid to the hydraulic actuator 152. In some cases, the motor 144 can be coupled to the pump 148 via a transmission 160 (e.g., a gear reducer).

Still referring to FIGS. 1-4, the hydraulic tool 100 includes the hydraulic actuator 152. The hydraulic actuator 152 is supported by the housing 112 and includes a hydraulic cylinder 178 and a ram 182 movably disposed within the hydraulic cylinder 178. The pump 148 supplies hydraulic fluid from a reservoir 174 (e.g., a tank) to the hydraulic cylinder 178. The reservoir 174 is positioned in the housing 112 and is fluidly coupled to the hydraulic actuator 152. The ram 182 moves within the hydraulic cylinder 178 in response to hydraulic fluid being provided from the reservoir 174 to the hydraulic cylinder 178 by the pump 148 and fluid being drained from the hydraulic cylinder 178 to the reservoir 174.

A pump assembly for a hydraulic tool can include a camshaft that is rotated by a motor, which in turn reciprocates a piston to provide pressurized hydraulic fluid to a hydraulic actuator. The motor 144 is coupled to the camshaft 280 to rotate the camshaft 280.

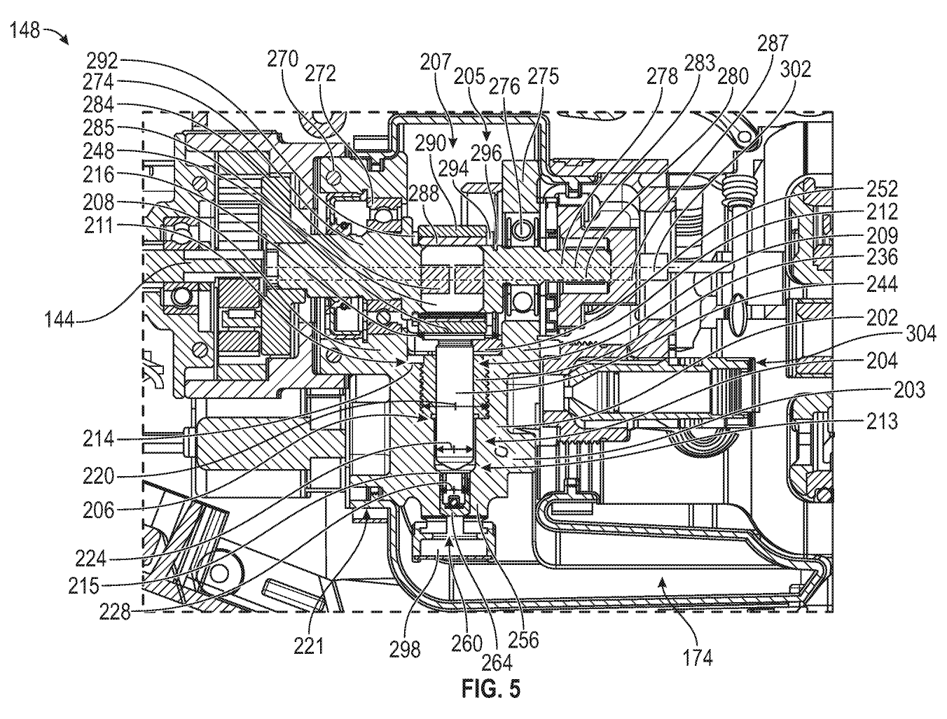

With additional reference to FIG. 5, the pump 148 includes a pump body 202 that includes a piston chamber body 203. The pump body 202 defines a piston chamber 204 and an inlet passage (e.g., inlet 260) and an outlet passage (e.g., outlet 268) that are coupled to the piston chamber 204. The piston chamber body 203 defines a first chamber 205 and a second chamber 206. The first chamber 205 defines an open end 207 and an opening 209, opposite of the open end 207. The second chamber 206 also defines the piston chamber 204 that has an open end 211 and a closed end 213. The open end 211 of the piston chamber 204 corresponds to the opening 209 of the first chamber 205 and defines a top surface 214. The closed end 213 of the piston chamber 204 defines a base surface 215 (e.g., a bottom surface).

The piston chamber 204 receives a piston 244 therein so that the piston 244 can move within the piston chamber 204 to cause pumping of a hydraulic fluid. The piston 244 is movably disposed within the piston chamber 204. That is, movement of the piston 244 in a first direction (e.g., out of the piston chamber 204) causes fluid to be drawn into the piston chamber 204 (e.g., from the reservoir 174 or another fluid source, such as a cylinder chamber of a hydraulic actuator). The fluid can be drawn into the piston chamber 204 via an inlet 260 (e.g., an inlet passage) defined in the pump body 202. The inlet 260 is coupled between the reservoir 174 and the piston chamber 204. In the illustrated example, the inlet 260 is positioned at a bottom 256 of the piston chamber body 203, as can allow for improved packaging. In other examples, the inlet 260 can be positioned differently. Correspondingly, movement of the piston 244 in a second direction (e.g., into the piston chamber 204) causes pressure to build within the piston chamber 204 and forces the fluid therein to be pushed out of the piston chamber 204 via an outlet 268 (e.g., an outlet passage) in the pump body 202. The outlet 268 is coupled to the piston chamber 204.

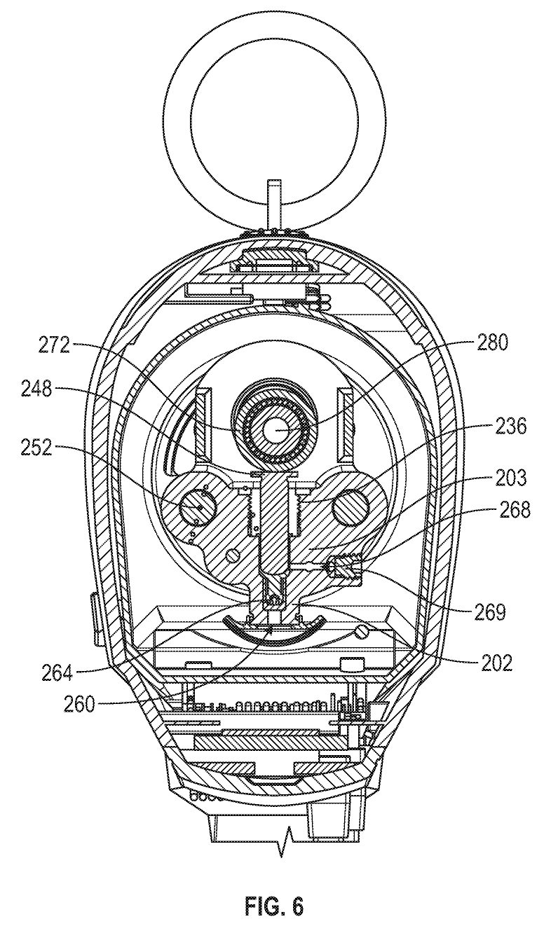

Referring to FIG. 6, the outlet 268 is positioned at the piston chamber body 203. The outlet 268 is fluidly coupled to the piston chamber 204. In other examples, the outlet 268 can be positioned differently. Fluid exiting the outlet 268 is supplied to the hydraulic actuator 152. The outlet 268 provides a flow path for pressurized hydraulic fluid to travel from the piston chamber 204 to the hydraulic cylinder 178. As the piston 244 moves in the second direction into the piston chamber 204, pressure builds within the piston chamber 204. The pressurized fluid is forced out of the piston chamber 204 through the outlet 268.

In some cases, a valve or valve system can be positioned between the outlet 268 and the hydraulic actuator 152 to control filling of the hydraulic actuator 152 (e.g., for single or multi-stage extension or retraction). For example, as shown in FIG. 6, a check valve 269 (e.g., a cartridge valve) is provided at the outlet 268 of the pump body 202. The check valve 269 is positioned along the outlet passage (e.g., outlet 268) to prevent fluid flow back into the piston chamber 204 along the outlet passage. The check valve 269 prevents backflow of fluid from the hydraulic actuator 152 into the piston chamber 204. The check valve 269 allows fluid to flow from the piston chamber 204 to the hydraulic actuator 152 when pressure within the piston chamber 204 exceeds pressure within the hydraulic actuator 152. The check valve 269 closes when pressure within the hydraulic actuator 152 exceeds pressure within the piston chamber 204.

The check valve 269 can be configured as a cartridge valve (e.g., The Lee Company® check valve or another style of cartridge valve) to reduce pump size and allow for improved maintenance. The cartridge valve configuration requires less space than other valve configurations. The cartridge valve configuration allows for easy replacement of the check valve 269 during maintenance operations. In some examples, the check valve 269 can include a ball that seats against the outlet 268 to prevent backflow. The check valve 269 improves volumetric efficiency of the pump 148 by preventing loss of pressurized fluid back into the piston chamber 204.

In some examples, the check valve 269 is non-removable from the outlet 268. In some examples, the check valve 269 is press-fitted into the outlet 268. In other examples, the check valve 269 is bonded to the pump body 202 at the outlet 268. A non-removable configuration can prevent inadvertent displacement of the check valve 269 during operation of the pump 148, provide improved sealing, and reduce the risk of leakage at the outlet 268.

In some examples, the check valve 269 is removable from the outlet 268. In some examples, the check valve 269 is configured as a cartridge valve that is threadably engaged with the pump body 202 at the outlet 268. A removable configuration of the check valve 269 can facilitate inspection and servicing of the pump 148. The removable configuration can also allow for replacement of the check valve 269 without requiring replacement of the pump body 202. In some cases, the check valve 269 can be removed using a tool, such as a wrench or a socket. In other cases, the check valve 269 can be removed by hand.

In some cases, a liner or sleeve can be positioned in a piston chamber to improve sealing between the piston and the piston body, as can improve pressure generation and volumetric efficiency. For example, as shown in FIG. 5, the pump 148 includes a piston sleeve 236 that is received in the piston chamber 204. The piston sleeve 236 is positioned in the piston chamber 204 and slidably receives the piston 244. The piston sleeve 236 is an annular member that defines an opening to slidably receive the piston 244. To accommodate the piston sleeve 236, the piston chamber 204 can have a variable diameter. For example, the piston chamber 204 defines a first diameter 216, a second diameter 220, a third diameter 224, and a fourth diameter 228. The first chamber 205 defines the first diameter 216. The top surface 214 of the piston chamber 204 defines the second diameter 220. The piston sleeve 236 is received within the second diameter 220. As illustrated, the piston sleeve 236 includes threads to be threaded into the piston chamber body 203. In some cases, the piston sleeve 236 can be press-fitted. The base surface 215 of the piston chamber 204 defines the third diameter 224. The bottom 256 of the piston chamber body 203 defines the fourth diameter 228.

A retainer can be coupled to a piston (e.g., an end of a piston) to prevent a biasing member from moving out of place. A biasing member (e.g., a spring) can be positioned between the retainer and a piston sleeve. The biasing member allows the piston to move in a first direction and a second direction. For example, a retainer 248 is coupled to an end of the piston 244. In some cases, as shown in FIG. 5, the retainer 248 is formed with the piston 244. The end of the piston 244 is positioned outside of the piston chamber 204 (e.g., within the first diameter 216). A biasing member 252 (e.g., a spring) is positioned between the retainer 248 and the piston sleeve 236. The biasing member 252 is positioned between the pump body 202 and the retainer 248. The piston 244 moves in the first direction as the biasing member 252 increases in length. The piston 244 moves in the second direction as the biasing member 252 decreases in length.

To move (e.g., reciprocate) the piston 244 within the piston chamber 204, the pump 148 can include a camshaft 280 that is rotated by the motor 144. The camshaft 280 is rotatably supported by the pump body 202 so that rotation of the camshaft 280 causes the piston 244 to reciprocate within the piston chamber 204. The camshaft 280 includes a cam 284, an inner bearing (e.g., first sleeve 288) made of a first material and sleeved on the cam 284, and an outer bearing (e.g., second sleeve 290) made of a second material that is different from the first material and sleeved on the inner bearing so that the inner bearing is between the outer bearing and the cam 284. The biasing member 252 is positioned between the piston 244 and the pump body 202 to bias the piston 244 into contact with the outer bearing (e.g., second sleeve 290) so that the piston 244 oscillates within the piston chamber 204 in response to rotation of the cam 284. The biasing member 252 biases the piston 244 toward the camshaft 280. The biasing member 252 maintains contact between the piston 244 (e.g., the retainer 248) and the camshaft 280 during rotation of the camshaft 280. As the camshaft 280 rotates, the piston 244 reciprocates within the piston chamber 204. The piston 244 moves in the first direction as the biasing member 252 increases in length. The first direction corresponds to movement of the piston 244 out of the piston chamber 204. Movement of the piston 244 in the first direction causes fluid to be drawn into the piston chamber 204 via the inlet 260. The piston 244 moves in the second direction as the biasing member 252 decreases in length. The second direction corresponds to movement of the piston 244 into the piston chamber 204. Movement of the piston 244 in the second direction causes pressure to build within the piston chamber 204. The pressurized fluid is forced out of the piston chamber 204 via the outlet 268.

A first flange can define a first journal housing and a second flange can define a second journal housing. For example, the pump body 202 includes a first flange 208 and a second flange 212, which are positioned in an opposed configuration about the piston chamber body 203 that defines the piston chamber 204. The pump body 202 includes a piston chamber body 203 positioned between the first flange 208 and the second flange 212. The second flange 212 is coupled to the hydraulic cylinder 178 of the hydraulic actuator 152. The first flange 208 defines a first journal housing 270 to receive a first bearing 272 and a first journal 274 of the camshaft 280. The second flange 212 defines a second journal housing 275 to receive a second bearing 276 and a second journal 278 of the camshaft 280. A cam 284 (e.g., an eccentric cam) is positioned between the first journal 274 and the second journal 278 to contact the piston 244 and cause the piston 244 to reciprocate in the piston chamber 204. In the illustrated example, the cam 284 is configured as an eccentric cam 285 with a cam axis 287 that is offset from a rotational axis 283 defined by the first journal 274 and the second journal 278. The first flange 208 defines the first journal housing 270 to receive the first journal 274 and the second flange 212 defines the second journal housing 275 to receive the second journal 278 so that the cam 284 is disposed within the reservoir 174.

In some cases, a piston can directly contact the camshaft. Direct contact between the piston and the camshaft can create friction and increase wear, thereby reducing efficiency of the overall system. In some cases, it can be beneficial to include a set of one or more sleeves on a camshaft, as can reduce friction and improve wear resistance and volumetric efficiency. In the illustrated example, the cam 284 includes a first sleeve 288 (e.g., an inner bearing) made of a first material and sleeved on the cam 284, and a second sleeve 290 (e.g., an outer bearing) made of a second material that is different from the first material. The second sleeve 290 is received on the first sleeve 288 so that the first sleeve 288 is positioned between the second sleeve 290 and the cam 284. The first sleeve 288 and the second sleeve 290 prevent the retainer 248 on the piston 244 from directly contacting the cam 284. The second sleeve 290 can be made of a different material than the retainer 248 to have a lower coefficient of friction and help reduce wear. In some examples, the first material is a metallic material and the second material is a polymeric material. It may be beneficial in some cases to have another bearing disposed between the first sleeve 288 and the second sleeve 290, or to have the first sleeve 288 without the second sleeve 290.

In some examples, retainers can be coupled to a camshaft to retain a bearing sleeve on a cam. Still referring to FIG. 5, a first retainer 292 is coupled to the cam 284 between the first journal 274 and the second sleeve 290. A second retainer 294 is coupled to the cam 284 between the second journal 278 and the second sleeve 290. A third retainer 296 (e.g., a circlip, pin, etc.) is positioned between the second retainer 294 and the second journal 278. The third retainer 296 is positioned between the second retainer 294 and the second bearing 276.

In some cases, a pump body can be coupled to a reservoir so that at least a portion of the pump body is retained in the reservoir. These arrangements can allow for improved packaging, lubrication of moving portions of the pump, and an enhanced bladder clamp area. The reservoir allows for the portion of the pump to be lubricated with hydraulic fluid. This lubrication reduces wear and increases the overall efficiency of the pump. Further, the bladder clamp area (e.g., where the reservoir is attached to the pump) is improved to ensure a leak-proof seal and prevents liquid from escaping during operation. The bladder clamp area can be on a first flange and a cylinder of a hydraulic tool. For example, the pump 148 includes the reservoir 174 that is positioned within the housing 112. The reservoir 174 is coupled to the pump body 202 so that the pump body 202 is disposed within the reservoir 174. The reservoir 174 is coupled to the first flange 208 and the hydraulic cylinder 178 so that a portion of the pump 148 (e.g., between the first flange 208 and the second flange 212) is disposed within the reservoir 174. The reservoir 174 is coupled to the first flange 208 and to the hydraulic cylinder 178 so that the piston chamber body 203 is disposed within the reservoir 174. In some cases, the reservoir 174 and the pump 148 are positioned separately. A bladder clamp area 221 is on the first flange 208 and the hydraulic cylinder 178. The bladder clamp area 221 allows for the reservoir 174 to increase the sealing area to prevent liquid from escaping. A screen 298 is positioned between the inlet 260 of the pump body 202 and the reservoir 174.

In some examples, a check valve can be provided to prevent backflow from a piston chamber to a reservoir. The check valve can be provided at an inlet of the pump body. In some cases, a check valve can be configured as a cartridge valve (e.g., The Lee Company® check valve or another style of cartridge valve) to reduce pump size and allow for improved maintenance. A check valve 264 (e.g., a first cartridge valve) is provided at the inlet 260 and is positioned along the inlet passage (e.g., inlet 260) to prevent fluid flow out of the piston chamber 204 along the inlet passage. The check valve 264 prevents fluid flow from the piston chamber 204 to the reservoir 174. The check valve 264 allows fluid to flow through when the pressure is higher on an outer side (e.g., the reservoir 174) than an inner side (e.g., the piston chamber 204). The check valve 264 prevents fluid from returning to the outer side when the pressure is higher on the inner side than the outer side (e.g., a ball in the check valve 264 seats against the inlet 260). The check valve 264 requires less space and is located inside the reservoir 174 to reduce the risk of air ingestion that causes the pump 148 to unprime. The check valve 264 improves dead space in the piston chamber 204 because the check valve 264 is smaller in size. This smaller size improves the volumetric efficiency of the pump 148.

In some examples, the check valve 264 is non-removable from the inlet 260. In some examples, the check valve 264 is press-fitted into the inlet 260. In other examples, the check valve 264 is bonded to the pump body 202 at the inlet 260. A non-removable configuration can prevent inadvertent displacement of the check valve 264 during operation of the pump 148, provide improved sealing, and reduce the risk of leakage at the inlet 260.

In some examples, the check valve 264 is removable from the inlet 260. In some examples, the check valve 264 is configured as a cartridge valve that is threadably engaged with the pump body 202 at the inlet 260. A removable configuration of the check valve 264 can facilitate inspection and servicing of the pump 148. The removable configuration can also allow for replacement of the check valve 264 without requiring replacement of the pump body 202. In some cases, the check valve 264 can be removed using a tool, such as a wrench or a socket. In other cases, the check valve 264 can be removed by hand.

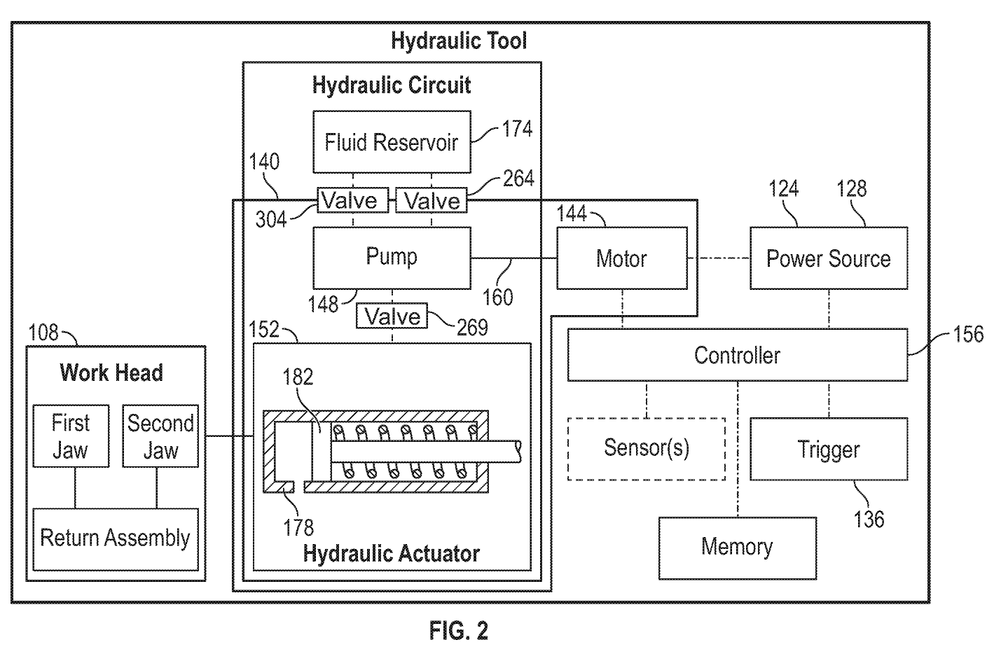

To control flow from a pump to an actuator a hydraulic tool to include a valve system to regulate fluid flow between the pump, the hydraulic actuator, and a fluid reservoir. Referring to FIGS. 2, 4, 5, and 7, the hydraulic tool 100 includes a shear valve 302 (e.g., a first valve). The shear valve 302 regulates fluid flow between the hydraulic actuator 152 and the pump 148. The shear valve 302 has a first position (e.g., an open position), a second position (e.g., a neutral position), and a third position (e.g., a closed position). When the shear valve 302 is in the first position, fluid flows between the pump 148 and the hydraulic cylinder 178. When the shear valve 302 is in the second position, fluid is restricted and does not flow between the pump 148 the hydraulic cylinder 178. The second position can be triggered by mechanical forces, excessive movement of the valve body, or when the shear valve 302 gets stuck. When the shear valve 302 is in the third position, fluid flows between the hydraulic actuator 152 and the reservoir 174. That is, in the third position, the shear valve 302 provides a return path for fluid to drain from the hydraulic actuator 152 to the reservoir 174. The third position allows fluid within the hydraulic cylinder 178 to be released back to the reservoir 174, thereby relieving pressure within the hydraulic actuator 152 and allowing the ram 182 to retract. The third position can be actuated to reset the hydraulic tool 100 after a work operation has been completed or to release pressure from the hydraulic actuator 152 when desired.

A hydraulic tool can include a pump passage to move fluid between a reservoir and a hydraulic actuator. For example, the hydraulic tool 100 includes a pump passage 304. The pump passage 304 extends between the reservoir 174, the pump 148, the shear valve 302, and the hydraulic actuator 152. The pump passage 304 includes a first pump passage 306 between the pump 148 and the shear valve 302. The pump passage 304 includes a second pump passage 308 between the shear valve 302 and the hydraulic actuator 152.

In some cases, a hydraulic tool can include a return valve (e.g., a dump valve) that allows fluid from a hydraulic actuator to return to a fluid reservoir (e.g., at end of stroke or via manual actuation by a user). The return valve provides a controlled pathway for releasing hydraulic pressure from the system after a work operation has been completed or when pressure release is otherwise desired. For example, the hydraulic tool 100 includes a dump valve 311 (e.g., a second valve) that is closed to block fluid flow from the hydraulic actuator 152 to the reservoir 174, and opened to allow fluid to flow from the hydraulic actuator 152 to the reservoir 174. When the dump valve 311 is in the closed position, hydraulic pressure is maintained within the hydraulic actuator 152, allowing the ram 182 to remain in an extended position. When the dump valve 311 is in the open position, hydraulic fluid is permitted to drain from the hydraulic actuator 152 back to the reservoir 174, thereby relieving pressure and allowing the ram 182 to retract.

In the illustrated example, the dump valve 311 includes the dump poppet 312 (e.g., or another type of control element such as a ball, spool, diaphragm, etc.) that moves between open and closed positions to control the dump valve 311. That is, the dump poppet 312 controls a flow path for fluid to travel from the hydraulic actuator 152 back to the reservoir 174. In some examples, the dump poppet 312 returns fluid from the hydraulic cylinder 178 to the reservoir 174. In some cases, the dump poppet 312 returns fluid from the pump 148 to the reservoir 174. In some examples, the dump poppet 312 is configured as a manual return. The manual return requires a user to actuate the dump poppet 312 to release pressure from the hydraulic actuator 152. In some cases, the manual return can be actuated by a second user interface coupled to the housing 112, such as a button, lever, or other input mechanism accessible to the user. In some examples, the dump poppet 312 is configured as an automatic return. The automatic return actuates the dump poppet 312 without requiring user input. In some cases, the automatic return can be triggered by the electronic controller 156 in response to a predetermined condition, such as detection of a completed work cycle, a maximum pressure threshold being reached, or a sensor signal indicating that the workpiece has been fully engaged.

The dump valve 311 is positioned along the pump passage 304. That is, the dump valve 311 is positioned along the first pump passage 306 between the pump 148 and the shear valve 302. More specifically, the dump poppet 312 is positioned along the first pump passage 306 between the pump 148 and the shear valve 302. The pump passage 304 defines a third pump passage 314 between the dump valve 311 and the reservoir 174. The dump valve 311 is positioned along the first pump passage 306 to return fluid from the hydraulic cylinder 178 to the reservoir 174 through the third pump passage 314 when the dump valve 311 is in the open position.

The dump valve 311 further includes a valve body 318 and a valve seat 320. The valve body 318 partially receives the dump poppet 312. The dump poppet 312 moves between open and closed positions by disengaging and engaging the valve seat 320. That is, the dump poppet 312 is in the open position when disengaged from the valve seat 320 and is in the closed position when engaged with the valve seat 320. The valve body 318 is positioned along the third pump passage 314 between the dump poppet 312 and the reservoir 174.

In some cases, a hydraulic tool can include a relief valve that connects a pump or a cylinder to a hydraulic reservoir when a pressure of the hydraulic tool exceeds a threshold pressure (e.g., a maximum operating pressure). The relief valve provides a safety mechanism to prevent damage to the hydraulic system by diverting fluid flow when excessive pressure is detected. In some examples, the hydraulic tool can exceed the maximum pressure when a shear valve is in a wrong position or becomes stuck. Referring to FIGS. 2, 4, 5, and 7, the hydraulic tool 100 includes a relief valve 310. The relief valve 310 is configured to move between a closed position and an opened position. The relief valve 310 is in the closed position during normal operation of the hydraulic tool 100. When the relief valve 310 is in the closed position, the relief valve 310 prevents fluid from flowing from the pump 148 or the hydraulic actuator 152 to the reservoir 174. This closed configuration allows the pump 148 to supply pressurized fluid to the hydraulic actuator 152 without loss of pressure through the relief valve 310. The relief valve 310 moves to the opened position when the threshold pressure is reached. When the relief valve 310 is in the opened position, the relief valve 310 allows fluid to flow through the relief valve 310 to the reservoir 174, thereby relieving the excess pressure within the hydraulic system. For example, the relief valve 310 is normally closed during normal operation of the hydraulic tool 100. The relief valve 310 opens when the pressure of the hydraulic tool 100 exceeds the maximum pressure. In some examples, the relief valve 310 is configured as a cartridge valve (e.g., The Lee Company® pressure relief valve or another style of cartridge valve) to reduce space requirements and facilitate maintenance.

The relief valve 322 is positioned along the pump passage 304. More specifically, the relief valve 322 is positioned along the first pump passage 306 between the pump 148 and the shear valve 302. The relief valve 322 is positioned along the first pump passage 306 to return fluid from the hydraulic cylinder 178 to the reservoir 174 through the third pump passage 314 when the relief valve 322 is in the open position.

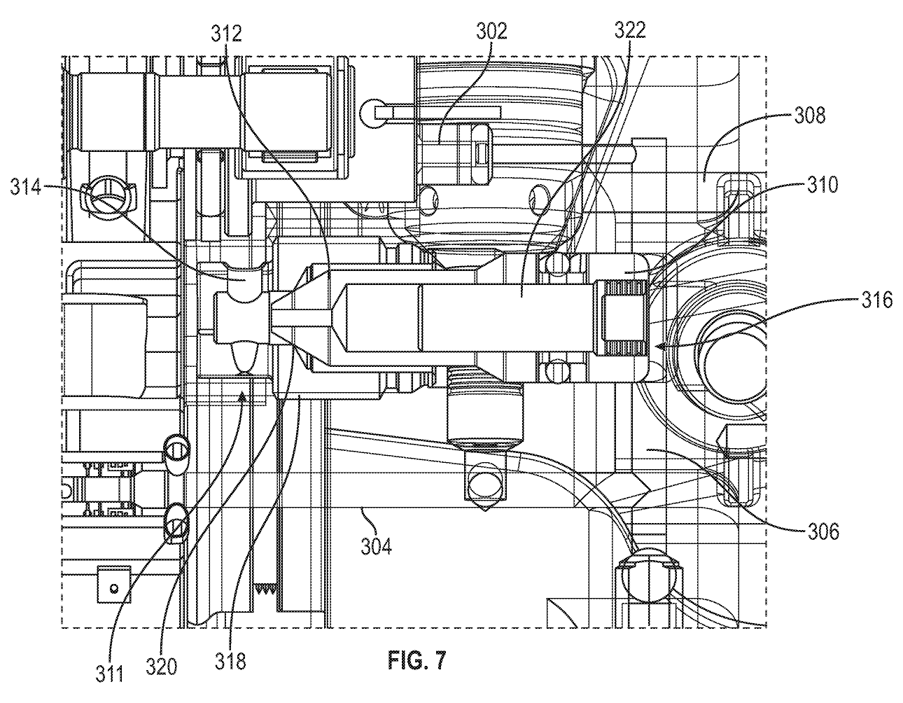

In some cases, a dump valve and a relief valve can be combined in a single valve assembly, as may simplify manufacturing or reduce tool weight. For example, still referring to FIG. 7, the hydraulic tool 100 includes a dual valve assembly 316 that incorporates both the dump poppet 312 and the relief valve 310 into a single integrated unit. The dual valve assembly 316 is positioned along the first pump passage 306 between the pump 148 and the shear valve 302. The dual valve assembly 316 provides both pressure relief functionality and fluid return functionality within a compact configuration.

The dual valve assembly 316 includes the dump poppet 312 and the relief valve 310. The dump poppet 312 defines an interior cavity that receives the relief valve 310. The relief valve 310 is positioned within the dump poppet 312 so that the dump poppet 312 and the relief valve 310 function as a single integrated valve unit. The relief valve 310 is coupled to the dump poppet 312 such that the relief valve 310 moves with the dump poppet 312 when the dump poppet 312 moves between the open position and the closed position. That is, when the dump poppet 312 moves to the open position to allow fluid to flow from the hydraulic actuator 152 to the reservoir 174, the relief valve 310 moves together with the dump poppet 312. Similarly, when the dump poppet 312 moves to the closed position to block fluid flow from the hydraulic actuator 152 to the reservoir 174, the relief valve 310 moves together with the dump poppet 312. This arrangement allows the relief valve 310 to maintain its position relative to the dump poppet 312 regardless of the operating state of the dump poppet 312, while still permitting the relief valve 310 to independently open when the threshold pressure is reached to relieve excess pressure within the hydraulic system.

In some examples, the relief valve 310 is press-fitted into the dump poppet 312. In other examples, the relief valve 310 is threadably engaged with the dump poppet 312. The press-fitted configuration can provide a secure, permanent connection between the relief valve 310 and the dump poppet 312, so that the relief valve 310 remains fixed within the dump poppet 312 during operation and movement of the dump poppet 312. The threadably engaged configuration can facilitate inspection, servicing, and replacement of the relief valve 310 without requiring replacement of the dump poppet 312.

The above discussion is presented to enable a person skilled in the art to make and use embodiments of the invention. Given the benefit of this disclosure, various modifications to the illustrated embodiments will be readily apparent to those skilled in the art, and the principles herein can be applied to other embodiments and applications without departing from embodiments of the invention. Thus, embodiments of the invention are not intended to be limited to embodiments shown, but are to be accorded the widest scope consistent with the principles and features disclosed herein.

The above detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

It is to be understood that the invention is not limited in its application to the details of construction and the arrangement of components set forth in the above description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

As also used herein, unless otherwise defined or limited, ordinal numbers are used herein for convenience of reference based generally on the order in which particular components are presented for the relevant part of the disclosure. In this regard, for example, designations such as “first,” “second,” etc., generally indicate only the order in which the relevant component is introduced for discussion and generally do not indicate or require a particular spatial arrangement, functional or structural primacy or order.

We claim:

1. A pump for a hydraulic tool, the pump including:
a pump body defining a piston chamber and an inlet passage and an outlet passage that are coupled to the piston chamber;
a piston movably disposed within the piston chamber;
a camshaft rotatably supported by the pump body, the camshaft including a cam, an inner bearing made of a first material and sleeved on the cam, and an outer bearing made of a second material that is different from the first material and sleeved on the inner bearing so that the inner bearing is between the outer bearing and the cam; and
a biasing member positioned between the piston and the pump body to bias the piston into contact with the outer bearing so that the piston oscillates within the piston chamber in response to rotation of the cam.

2. The pump of claim 1, wherein a retainer is coupled to an end of the piston that is positioned outside of the piston chamber and the biasing member is positioned between the pump body and the retainer.

3. The pump of claim 1, wherein a first cartridge valve is positioned along the inlet passage to prevent fluid flow out of the piston chamber along the inlet passage.

4. The pump of claim 3, wherein a second cartridge valve is positioned along the outlet passage to prevent fluid flow back into the piston chamber along the outlet passage.

5. The pump of claim 1, wherein the cam is an eccentric cam that is positioned between a first journal and a second journal, and
wherein the pump body includes a first journal housing to receive the first journal and a second journal housing to receive the second journal.

6. The pump of claim 5, wherein a first retainer is coupled to the cam between the first journal and the outer bearing and a second retainer is coupled to the cam between the second journal and the outer bearing.

7. The pump of claim 1 further comprising a piston sleeve positioned in the piston chamber, the piston sleeve slidably receiving the piston.

8. The pump of claim 1 further comprising a reservoir coupled to the pump body so that the pump body is disposed within the reservoir.

9. The pump of claim 1, wherein the first material is a metallic material and the second material is a polymeric material.

10. A power tool comprising:
a housing;
a hydraulic actuator supported by the housing and including a cylinder and a ram movably disposed within the cylinder;
a tank positioned in the housing and fluidly coupled to the hydraulic actuator;
a pump positioned in the housing, the pump including:
a pump body defining a piston chamber, an inlet passage coupled between the tank and the piston chamber, and an outlet passage coupled to the piston chamber,
a piston movably disposed within the piston chamber,
a camshaft rotatably supported by the pump body, the camshaft including a cam, an inner bearing made of a first material and sleeved on the cam, and an outer bearing made of a second material that is different from the first material and sleeved on the inner bearing so that the inner bearing is between the outer bearing and the cam, and
a biasing member positioned between the piston and the pump body to bias the piston into contact with the outer bearing so that the piston oscillates within the piston chamber in response to rotation of the cam; and
a motor coupled to the camshaft to rotate the camshaft.

11. The power tool of claim 10, wherein the pump body includes a piston chamber body positioned between a first flange and a second flange that is coupled to the cylinder of the hydraulic actuator; and
wherein the tank is coupled to the first flange and to the cylinder so that the piston chamber body is disposed within the tank.

12. The power tool of claim 11, wherein the cam is positioned between a first journal and a second journal, and
wherein the first flange defines a first journal housing to receive the first journal and the second flange defines a second journal housing to receive the second journal so that the cam disposed within the tank.

13. The power tool of claim 12, wherein a first retainer is coupled to the camshaft between the first journal and the outer bearing, and a second retainer is coupled to the camshaft between the second journal and the outer bearing.

14. The power tool of claim 13, wherein a third retainer is positioned between the second retainer and the second journal.

15. The power tool of claim 10, wherein a first cartridge valve is positioned along the inlet passage to prevent fluid flow from the piston chamber to the tank.

16. The power tool of claim 10, wherein a retainer is coupled to an end of the piston that is positioned outside the piston chamber.

17. The power tool of claim 16 further comprising a piston sleeve positioned in the piston chamber, the piston sleeve slidably receiving the piston.

18. The power tool of claim 10, wherein the first material is a metallic material and the second material is a polymeric material.

19. The power tool of claim 15, wherein a second cartridge valve is positioned along the outlet passage to prevent fluid flow back into the piston chamber along the outlet passage.

20. The power tool of claim 10, wherein a valve assembly is positioned along a pump passage between the pump and the hydraulic actuator, the valve assembly includes a dump poppet and a relief valve received within the dump poppet.

21. A power tool comprising:
a housing;
a hydraulic actuator supported by the housing and including a cylinder and a ram movably disposed within the cylinder;
a tank positioned in the housing and fluidly coupled to the hydraulic actuator;
a pump positioned in the housing, the pump including:
a pump body defining a piston chamber, an inlet passage coupled between the tank and the piston chamber, and an outlet passage coupled to the piston chamber, the piston chamber is disposed within the tank and the inlet passage and the outlet passage include a cartridge valve,
a piston movably disposed within the piston chamber, the piston including a retainer coupled to an end of the piston,
a camshaft rotatably supported by the pump body, the camshaft including a cam, an inner bearing made of a first material and sleeved on the cam, and an outer bearing made of a second material that is different from the first material and sleeved on the inner bearing so that the inner bearing is between the outer bearing and the cam, and
a biasing member positioned between the retainer and the pump body to bias the piston into contact with the outer bearing so that the piston oscillates within the piston chamber in response to rotation of the cam; and
a motor coupled to the camshaft to rotate the camshaft.
